(19) United States
(12) Patent Application Publication
(10) Pub. No.: US 2011/0204799 A1
(43) Pub. Date: Aug. 25, 2011

(54) Current driver for LED

(76) Inventor: John C. Albrecht, Chesterfield, MO (US)

(21) Appl. No.: 12/660,420

(22) Filed: Feb. 25, 2010

(51) Int. Cl. H05B 37/02

(52) U.S. Cl. 315/185 R; 315/291

(57) ABSTRACT

A current driver for powering an LED assembly comprises an input capacitor and a full wave rectifier. The LED assembly is connected to the rectifier output terminals. A driven LED assembly may be formed of series and parallel strings of individual LEDs. AC Line frequencies, e.g., 50 cycles, 60 cycles, non-line AC frequencies; and ranges of source voltages, e.g., 120 to 220 volts are accommodated by the driver. The driver provides essentially equal energy current pulses to the LED load, coincident with the time and the duration of the positive excursions of the input power. Energy is delivered to the LED load in a 50% duty cycle. Transfer of energy from an AC input power source to an LED assembly is independent of the output parameters of that source.

### BACKGROUND OF THE INVENTION

InGaN blue Light Emitting Diodes (LEDs) opened the way for manufacture of “white” light LED assemblies comprising a dice of InGaN and a light excited phosphor. White light LEDs are available in the forms of 3 mm, 5 mm and 10 mm bottles and Surface Mounted Devices (SMDs). High Power white LEDs, rated at 1 watt and 5 watts, are widely used. The foot print of the light of individual LEDs is determined principally by the shape and the material of the individual LED enclosures. All of the above products can be economically powered by the circuitry disclosed herein. Although manufacturers of white light LEDs publish “detailed specifications” of their products, specifications which are provided to a customer with a shipment, appear to differ from the published “detailed specifications”. Extensive testing of 5 mm LED products appears to indicate similar variations.

The forward current path through an (LED) is essentially free of resistance, and the series flow of current therein, produces a corresponding forward voltage which is directly related to the magnitude of the instantaneous current and the chemistry of the device. The operating currents for 100% illumination of InGaN LEDs, by way of example, range from 20 milliamps in low power 5 mm devices to 350 milliamps in high power devices. An InGaNi LED, in response to driving current, generates a forward voltage in the order of 3.2 volts. The life of an LED is shortened if overdriven with current and extended if even modestly under driven.

White light LED products, from competing suppliers, comprise essentially identical physical structures. However, there are wide variations in chromaticity, forward voltages, and brightness of their lights. Consequently, manufacturers “bin” their products to meet application demands.

The market place, is awash with an abundance of complex “controlled voltage” and “controlled current” drivers, which operate principally from less than 50 volt DC power sources.

The efficiencies of such drivers are limited by power losses in their respective circuits employed to control their output currents or voltages. It is not unusual to find commercial driver circuits claiming 90 percent efficiency. If a transformer and a rectifier are needed to provide the DC input voltages to a driver circuit, the overall efficiency from line voltage to DC LED driver current is substantially further reduced. There are few drivers available to operate at AC line voltages. Commercial semiconductor driver designers strive for complex circuits implemented with very small components. Unfortunately, commercially available drivers require added input and output components to adjust to the parameters of the power source and to the load. Consequently their application to a specific, load may require substantial application and packaging engineering, and the availability of fabrication facilities to get to the market.

### SUMMARY OF THE INVENTION

A driver, in accordance with the present invention, provides essentially equal energy current pulses to an LED load, coincident with the time and the duration of the positive excursions of the input power. Consequently, energy is delivered to the LED load in a 50% duty cycle.

The input energy required to drive an LED load is less than the energy required to drive the same LED load with DC.

A driver comprises an input capacitor, and a full wave rectifier. The LED load assembly is connected to the rectifier output terminals. The current path presented to the AC power source is capacitive and free of significant electrical resistance.

Energy pulses, at the frequency of the applied voltage, are sequentially transferred from the power source to the capacitor; from the capacitor to the rectifier and from the rectifier to the connected load via the output terminals of the rectifier.

A current driver directly drives a connected LED load. Only the power converted to light which is produced by the driven LEDs, and the concomitant related heat, is drawn from the alternating current power source.

Advantageously, the driver circuit of this invention presents a power factor correcting capacitive load to the applied alternating current input power source; automatically adapts to commercial power source frequencies; and to input voltages from 100 volts to at least 220 volts.

### THE DRAWING

FIG. 1. Illustrates a current driver of the present invention.

FIG. 2. Image of driving current pulses at node f.

FIG. 3 Chart

### DETAILED DESCRIPTION

Current driver 100 of FIG. 1 comprises storage capacitor 101, discharge resistor 102, Fuse 103, and full wave rectifier 120. Power source 200 provides Alternating Current to Driver 100 via input terminals a and j. In this example, Power Source 200 is a two wire, 120 volt, 60 cycle power supply. Output pulses of the driver 100 are delivered to the connected LED load 300 via rectifier output terminals f and g.

The connected load 300, comprises a planar array of 140, 5 mm, white LEDs.

The subject boards are populated with Ledman Optoelectronics Model LL1502HGWR1-C01 LEDs:

| | | | |
|---|---|---|---|
| Dimension: | 5 mm Round | CCT: | 3200K |
| Dice Material: | InGaN | Luminous Intensity: | 1500 mcd |
| Lens Color: | Water Transparent | Reverse Current: | 10 μA |
| Emission Color: | Warm White | 50% power Angle: | 120 |
| Forward current | 20 milliamps | Forward Voltage: | 3.2 V |
| at 100% | | | |
| illumination | | | |

Connected load 300 array is comprised of seven serially connected rows. Each row is formed of twenty parallel connected LEDs.

Transfer of energy in the form of current from power source 200 to LED assembly 300, via capacitor 101, is independent of the output parameters of power source 200. The instantaneous power drawn from source 200 is diminished by a multiplication factor corresponding to the reciprocal of the frequency of that source.

Transfer of energy from power source 200 to capacitor 101 occurs without significant power loss. Energy, at the frequency of the line voltage, is periodically pulse transferred from the power source 200 to add to the charge of capacitor 101. After the capacitor is fully charged, each successive input pulse effects transfer of equal pulses of energy from capacitor 101 to rectifier 120, and from rectifier 120 to the connected load 300 via the output terminals f and g of rectifier 120.

Because there is no measurable circuit resistance in the LED load 300, terminals f and g exhibit equal, but opposite, AC potentials with respect to terminal j, which is the neutral of AC power supply 200. The AC potential measured from terminal f or g to terminal j equals one half of the voltage generated by current flowing in the LED load from terminal f to terminal g. For example, if a string of seven LEDs generates 23 volts between terminals f and g, the potential between, terminal f or g to terminal j is 11.5 DC volts. Since the generated voltage is dependent only on the value of current flowing in the LED assembly 300, the generated voltage is independent of the output voltage of supply 200.

Although, Driver 100 is a “feed forward” device, its current pulses remain essentially equal for a wide range of power supply voltages, e.g., 100 to 220 volts.

Current driver 100, directly drives connected load 300. Consequently, only the power which is converted to light by the driven LEDs, and the concomitant heat, is drawn from the alternating current power source.

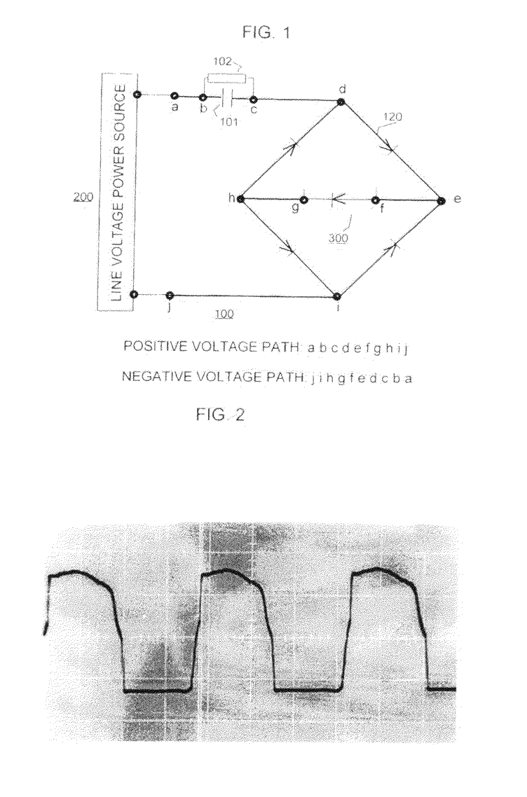

FIG. 2 is an oscilloscope image portraying two full time periods of current pulses flowing from terminal c to terminal j. Time on the image runs from left to right. The distance, from left to right between any pair of pulses corresponds to the time period of one full cycle of the AC source wave, e.g., 60 cycles. Thus, the time between pulses is 0.0166 seconds.

Diode load 300, permits free flow of positive current pulses through POSITIVE VOLTAGE PATH: a b c d e f g h l j, during the positive wave of source 200; and blocks path g f e d c during the negative wave of source 200. Capacitor 102 is charged during the positive half of the input power cycle, and the accumulated charge is retained during the negative half of the input power cycle. Consequently, after capacitor 101 reaches full charge, subsequent positive input pulses transfer equal amounts of energy forward to load 300.

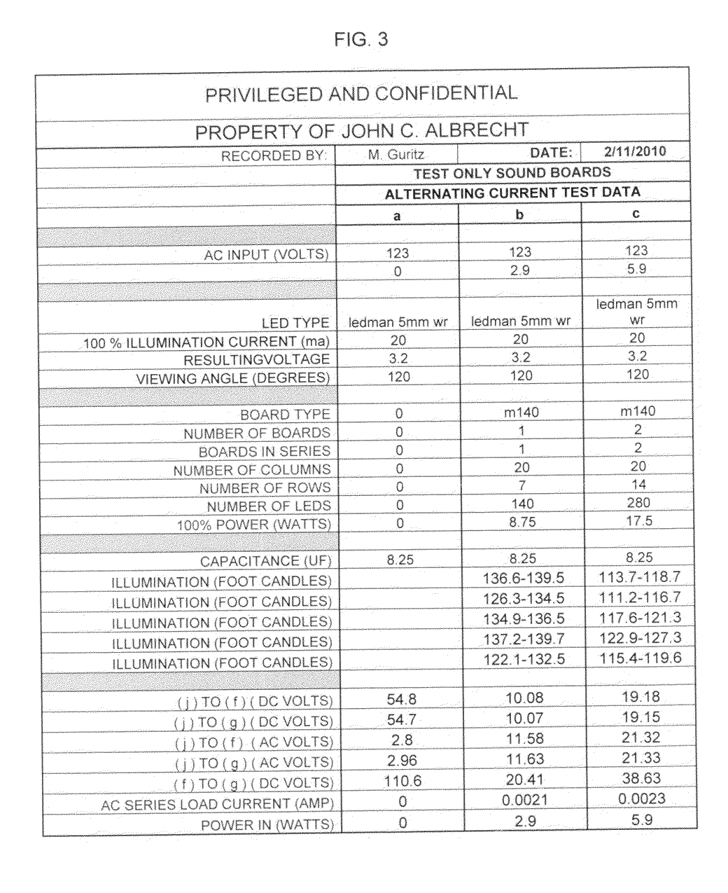

The image of FIG. 2 and the data of FIG. 3 explain the simplicity and resilience of FIG. 1 in serving ranges of loads.

FIG. 3 must be read with respect to nodes a through j of FIG. 1. Terminal j is the neutral of Power Source 200, f is the positive input terminal of LED load 300, and g is the negative terminal of load 300.

FIG. 2 is an image of an oscilloscope connected between power neutral node j, and rectifier output terminal f. The image records a time dependent voltage, resulting in time and amplitude from a current pulse flowing through LED assembly 300.

The wave is essentially, equally centered vertically about the “base line” of the oscilloscope grid. The flat portion of the wave corresponds in time to the negative excursions of the connected AC supply 200; and the pulse portions of the wave correspond in time to the positive excursions of the connected AC supply 200

The amplitude of a wave, between peak and flat, corresponds to the voltage generated by the LED assembly in response to flowing current. Since the current path from node f to node g has negligible circuit resistance, the voltage from node f to node g was determined by measuring the AC voltage between neutral node j and f, and the AC voltage between neutral node j and g. The numerical sum of those two voltages is the AC voltage between node f and node g in response to a current pulse.

The AC voltage between node f and node g, corresponds in value to the number of LEDs connected in series. In column b of FIG. 3, the AC voltage from node f to node g is 23.21 volts, i.e., 11.58 plus 11.63 for 7 LEDs in series in load 300.

Column c of FIG. 3 records data of an assembly which is comprised 14 LEDs in series. For that arrangement, the AC voltage from node f to g is 42.65, i.e., the sum of 21.32 plus 21.33.

In the examples recorded in columns b and c, of FIG. 3, power in watts, drawn from source 200 is the product of “AC voltage from f to g x series AC current x 60”.

Example b of FIG. 3, powers 140 5 mm LEDs arranged in twenty parallel columns, each column is comprised of 7 series connected LEDs. The AC power drawn is: 0.0021×60×23.21=2.92 watts.

If the assembly 300, is driven by DC and produces the same reported levels of illumination in foot candles, the DC power drawn is 6 watts.

In example c of FIG. 3, the assembly of 280 LEDs is comprised of 20 columns and 14 rows. The AC power drawn by above AC driver consumes 2.7 watts, and the DC driver draws 5 watts.

The driver circuit of FIG. 3 provisioned with an 8.25 micro farad capacitor produced the target ranges of reported light levels. Different target levels of illumination of an LED assembly can be met by matching the capacitance of capacitor 101 to the structure and target illumination levels of LED assembly 300.

The illumination levels reported in FIG. 3 were measured by use of a light meter receiving light via a tube positioned on an LED to assure uniformity in determining light values.

What is claimed is:

1) A current driver, for powering an LED load, comprising:
(a) first and second driver input terminals for receiving alternating current,
(b) a capacitor comprising a capacitor input terminal connected to said first driver input terminal, and a capacitor output terminal;
(c) a full wave rectifier comprising:
a first rectifier input terminal connected to said capacitor output terminal,
a second rectifier input terminal connected to said second driver input terminal, and
first and second rectifier load terminals for providing driving current to an LED load connected thereto.

2) A current driver in accordance with claim 1, wherein
said connected load may comprise selected series and parallel arrays of LEDs.

3) A current driver in accordance with claim 1 wherein:
said current driver accommodates to any alternating current source ranging from 100 volts to 220 volts.

4) A current driver in accordance with claim 1, wherein:
the capacitance of said capacitor is selected to support a selected target range of emitted light values.

5) A current driver in accordance with claim 1, wherein:
the capacitance of said capacitor is selected to support the number of series connected LEDs in a connected LED load assembly.

6) A current driver in accordance with claim 1, wherein:
the capacitance of said capacitor is selected to support the number of parallel connected LEDs in a connected LED load assembly.
